(19) United States
(12) Patent Application Publication
(10) Pub. No.: US 2005/0270463 A1
(43) Pub. Date: Dec. 8, 2005

(54) Bistable liquid crystal display device

(75) Inventors: Tadashi Akahane, Tokyo (JP); Munehiro Kimura, Tokyo (JP); Yuzo Hayashi, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/145,825

(22) Filed: Jun. 6, 2005

(30) Foreign Application Priority Data
Jun. 8, 2004 (JP) 2004-169739

(51) Int. Cl. G02F 1/1337

(52) U.S. Cl. 349/129

(57) ABSTRACT

A bistable liquid crystal display device includes nematic liquid crystal that is interposed between a pair of substrates, an orientation film that is subjected to a uniform inclined orientation treatment and an electrode, on one of the substrates, and an orientation film that has alternately formed vertical and horizontal orientation regions and an electrode, on the other substrate. An angle of an easy orientation axis of liquid crystal molecules close to the other substrate is changed between an orientation state in which one end of the easy orientation axis of the liquid crystal molecules is inclined toward the one substrate with respect to a normal of the pair of substrates and an orientation state in which the one end is inclined toward the other substrate.

### BACKGROUND OF THE INVENTION

1. Field of the Invention

The present invention relates to a bistable liquid crystal display device in which nematic liquid crystal has two stable orientation states.

2. Description of the Related Art

Generally, in a liquid crystal display device using nematic liquid crystal, even when the same image is displayed, an electric field needs to be continuously applied to the liquid crystal. Accordingly, in an electronic apparatus, such as a cellular phone or the like, having such a liquid crystal display device, it has been known that power consumption at the time of a standby state reaches 20%. For this reason, bistable liquid crystal display devices in which power does not need to be applied when the same image is displayed and the display is held have been competitively developed.

As such a bistable liquid crystal display device, a liquid crystal display device, which is referred to as a ZBD (Zenithal Bistable Display), has been widely known. The liquid crystal display device referred to as the ZBD has a basic configuration in which nematic liquid crystal is interposed between a pair of substrates, that is, a sandwich structure. In this case, an interface of an orientation film on one substrate is vertically oriented (or horizontally oriented) and an interface of an orientation film on the other substrate has a structure in which minute gratings are provided. Further, on the grating structure, a vertical orientation treatment is performed.

FIG. 8 shows a schematic structure of an example of such a ZBD-type liquid crystal display device. In the ZBD-type liquid crystal display device, liquid crystal is filled between a pair of substrates 100 and 101. On the lower surface of the upper substrate 100, a grating part 103 which has minute concavo-convexes having a depth and a pitch of from 1 to 2 μm is formed. Each concavo-convex has a triangular section. Further, the surface of the grating part 103 on the upper substrate 100 is subjected to the vertical orientation treatment. The entire surface of an orientation film (not shown) formed on the lower substrate 101 serves as the vertical orientation region. The groove direction of the grating part 103 (the vertical direction in FIG. 8) is tilted with respect to a quadrature polarizer, which is disposed outside the upper substrate 100 or the lower substrate 101, at the angle of 45°

In the above-described structure, polarizing plates (not shown in FIGS. 8A and 8B) are disposed outside the substrates 100 and 101 under a crossed nicols condition. Thus, when a driving pulse electric field is applied such that electric force lines act in an E₁ direction, as shown in FIG. 8A, a dark display is performed. Further, when the driving pulse electric field is applied such that the electric force lines act in an E₂ direction, as shown in FIG. 8B, a bright display is performed. Therefore, the ZBD-type liquid crystal display device has a bistable structure in which the two orientation states of the liquid crystal can be held even if the electric field is removed after driving pulses are applied.

The basic concept and the detail structure of the ZBD-type liquid crystal display device constituted in such a manner is disclosed in PCT Japanese Translation Patent Publication Nos. 9-508714 and 2002-500383.

In the ZBD-type liquid crystal display device having the above-described structure, the grating part 103, which has periodical triangular shapes having a size in an order of micrometer and in which the vertical orientation treatment is performed on the surfaces of the triangular shapes, should be formed on the upper substrate 100 near the liquid crystal. However, with the current film-formation technique, it is very difficult to form the minute periodical concavo-convexes of from 1 to 2 μm so as to have an accurate shape and to impart the vertical orientation property thereon. Accordingly, at the present, the ZBD-type liquid crystal display device is used for study, but is not suitable for mass production. For mass production, various techniques need to be developed.

In addition, according to PCT Japanese Translation Patent Publication Nos. 9-508714 and 2002-500383 and the like, a technique in which bistability is realized with the vertical orientation state and a homogeneous orientation state horizontal to the substrate, as well as the above-described two vertical orientation states, has been known. For example, as shown in FIG. 8A, since one inclined surface 103a and the other inclined surface 103b of the triangular convex in the grating part 103 have different directions, in the liquid crystal orientation state of the above-described homogeneous orientation state, a problem occurs in the liquid crystal orientation property along any one of the inclined surfaces in view of polarization. For example, when the liquid crystal is transferred to an orientation state and then the liquid crystal molecules are arranged, it is not defined whether the orientation state of the liquid crystal is tilted in the right side or the left side at the time of the start of the orientation. Accordingly, there are multiple random domains in which the liquid crystal molecules are arranged in different directions, that is, the right direction and the left direction. Due to the occurrence of these domains, display irregularity may occur.

Therefore, conventionally, in order to implement the bistable liquid crystal display device, it is highly desirable to realize a bistable structure of the liquid crystal, without forming the minute grating structure having a problem difficult to settle.

### SUMMARY OF THE INVENTION

The invention has been made in consideration of the above-described problems, and it is an object of the invention to provide a bistable liquid crystal display device that can realize bistability even when a structure not having a minute grating part required for the conventional structure is used. It is another object of the invention to provide a bistable liquid crystal display device that can be easily manufactured and that can realize bistabilization, with no domains or the like.

According to a first aspect of the invention, there is provided a bistable liquid crystal display device including nematic liquid crystal that is interposed between a pair of substrates, an orientation film that is subjected to a uniform inclined orientation treatment and an electrode that drives the liquid crystal, on one of the substrates, and an orientation film that has vertical orientation regions and horizontal orientation regions alternately formed and an electrode for driving the liquid crystal, on the other substrate. When an electric field that generates electric force lines toward the one substrate is applied from the electrodes on the pair of substrates and when an electric field that generates electric force lines toward the other substrate is applied from the electrodes on the pair of substrates, an angle of an easy orientation axis of liquid crystal molecules close to the other substrate is changed between an orientation state in which one end of the easy orientation axis of the liquid crystal molecules is inclined toward the one substrate with respect to a normal of the pair of substrates and an orientation state in which the one end of the easy orientation axis of the liquid crystal molecules is inclined toward the other substrate with respect to the normal of the pair of substrates is changed, such that a bistable state in which two orientation states are stabilized is revealed.

According to a second aspect of the invention, there is provided a bistable liquid crystal display device including nematic liquid crystal that is interposed between a pair of substrates, an orientation film that is subjected to a uniform inclined orientation treatment on one of the substrates, an orientation film that has vertical orientation regions and horizontal orientation regions to be alternately formed on the other substrate, and electrodes that is formed on at least one of the pair of substrates to drive the liquid crystal and to generate a horizontal electric field. When a horizontal electric field is applied from the electrodes for driving the liquid crystal in a direction along the vertical orientation regions and the horizontal orientation regions to be alternately formed and when a horizontal electric field is applied from the electrodes for driving the liquid crystal in an opposite direction to the direction, an angle of an easy orientation axis of liquid crystal molecules close to the other substrate is changed between an orientation state in which one end of the easy orientation axis of the liquid crystal molecules is inclined toward the one substrate with respect to a normal of the pair of substrates and an orientation state in which the one end of the easy orientation axis of the liquid crystal molecules is inclined toward the other substrate with respect to the normal of the pair of substrates, such that a bistable state in which the two orientation states are stabilized is revealed.

Generally, the nematic liquid crystal is defined as an aggregate of liquid crystal molecules having different shapes such as wedge-shaped liquid crystal molecules or banana-shaped liquid crystal molecules. In a normal state in which distortion is not applied to the nematic liquid crystal, the wide parts and the narrow parts of the liquid crystal molecules having different shapes get into each other. Then, the nematic liquid crystal is held in a stable state in which a dipole moment is seemingly canceled.

However, when the distortion, such as splay (expansion) or bend, is applied to the orientation state of the nematic liquid crystal as the aggregate of the liquid crystal molecules having various shapes, the dipole moment is biased and therefore a polarization occurs. This phenomenon can be referred to as a polarization phenomenon due to a flexoelectric effect. The value of the polarization due to the flexoelectric effect can be derived from the sum of a value of a spontaneous polarization due to a splay deformation of the wedge-shaped liquid crystal molecules and a value of a spontaneous polarization due to a bend deformation of the banana-shaped liquid crystal molecules.

Specifically, the nematic liquid crystal to which the splay deformation or the bend deformation is applied has the spontaneous polarization. Thus, when a predetermined electric field is applied to the nematic liquid crystal, the nematic liquid crystal has a specific orientation state according the spontaneous polarization. When the nematic liquid crystal is oriented in a state in which a proper spontaneous polarization is generated by the orientation films on the substrates, bistability of the nematic liquid crystal can be revealed by selecting the application condition of the electric field according to the spontaneous polarization revealed by the nematic liquid crystal and by changing the application condition. The nematic liquid crystal oriented once in the specific orientation state by the electric field tries to hold the state since the state of the spontaneous polarization is stably held even though the electric field is removed. In other to change to another state, it is necessary to apply a special electric field toward another direction.

In order to allow the bistability to be revealed, first, the orientation film on the one substrate is subjected to the uniform inclined orientation treatment, the vertical orientation regions and the horizontal orientation regions are alternately formed on the other substrate, and the spontaneous polarization is revealed in the nematic liquid crystal by distortion applied thereto. Then, when electric force lines toward the one substrate in a direction perpendicular to the substrates are generated and when electric force lines toward the other substrate in a direction perpendicular to the substrates are generated, from the electrodes on the substrates, two stable orientation states can be changed based on the spontaneous polarization of the nematic liquid crystal, thereby allowing the bistability to be revealed.

Further, the direction of the electric field applied is not limited to the two directions. In a structure in which the nematic liquid crystal is sealed between the pair of substrates, the direction of the electric field applied can be changed between two different directions in the surface direction of the substrates. Specifically, the horizontal electric field is changed between the two directions.

In the bistable liquid crystal device according to the first or second aspect of the invention, when a flexoelectric polarization due to a flexoelectric effect occurs in the nematic liquid crystal, the bistable state is changed by a torque due to the flexoelectric polarization and a torque due to an orientation flow effect.

By the torque due to the flexoelectric polarization, the bistability having two stable orientation states can be revealed according to the electric field to be applied. The orientation flow effect due to the liquid crystal oriented according the electric field is generated and therefore entire liquid crystal shows smoothly a desired orientation. The liquid crystal in a region outside the part in which the electrodes are provided is smoothly oriented by the orientation flow effect. Accordingly, the bistability of the entire liquid crystal can be revealed. Since orientation control force due to the torque by the flexoelectric polarization and the orientation flow effect is sufficient to orient the liquid crystal molecules, the liquid crystal display device has an advantage in that the grating part needs to be provided and the vertical orientation regions and the horizontal orientation regions are alternately formed. Accordingly, the structure can be simplified, as compared to the ZBD-type liquid crystal display device, and the liquid crystal display device can be manufactured. Furthermore, the liquid crystal display device which can solve a display failure, which may occur due to multiple domains in the ZBD type liquid crystal display device.

It is preferable that a rubbing treatment is performed on the orientation film on the other substrate in an alternate formation direction of the vertical orientation regions and the horizontal orientation regions on the other substrate or along a direction perpendicular to the alternate formation direction.

The width and the pitch of each of the vertical orientation regions and the horizontal orientation regions are in a range of from 1 to 10 μm, and preferably, in a range of from 1 to 2 μm. When the total area of the vertical orientation regions is substantially equal to the total area of the horizontal orientation regions, the vertical orientation regions and the horizontal orientation regions may be arbitrarily arranged. The arrangement type of the vertical orientation regions and the horizontal orientation regions may be an alternate arrangement of stripe shapes, an alternate arrangement of grads or lattices, an arrangement, such as a stripe arrangement or mosaic arrangement, generally known as an arrangement for color filters of liquid crystal devices, a random arrangement, a random number arrangement, or the like.

It is preferable that a pretilt angle of the orientation film subjected to the uniform inclined orientation treatment on the one substrate is in a range of 45°±5° and a pretilt angle of the horizontal orientation regions of the orientation film on the other substrate is in a range of 70°±5°.

In order to reliably obtain the bistability, as the angle of the orientation film, the above-described angles can be exemplified.

It is preferable that the vertical orientation regions and the horizontal orientation regions on the other substrate can have stripe shapes, respectively, and are alternately arranged along the surface direction of the other substrate.

It is preferable that the vertical orientation regions and the horizontal orientation regions on the other substrate can have rectangular shape, respectively, and are alternately arranged along the surface direction of the other substrate.

The arrangement type of the vertical orientation regions and the horizontal orientation regions may be an alternate arrangement of stripe shapes, an alternate arrangement of grads or lattices, a random alternate arrangement, or the like. The total area of the vertical orientation regions may be substantially equal to the total area of the horizontal orientation regions. Thus, a bistable liquid crystal display device in orientation irregularity or domain is hardly generated.

The bistable liquid crystal device according to the first or second aspect of the invention further includes optical compensation films that are disposed outside the substrates. An orientation direction of the liquid crystal in the horizontal orientation regions on the other substrate crosses directions of polarization axes of the optical compensation films at an angle of ±45°.

### BRIEF DESCRIPTION OF THE DRAWINGS

FIG. 1 is a diagram showing a schematic configuration of a liquid crystal display device according to the invention;

FIG. 2A is a diagram illustrating an orientation state of all liquid crystal molecules in an example of a first stable orientation state of the liquid crystal molecules of the liquid crystal display device;

FIG. 2B is a diagram illustrating the orientation state of the liquid crystal molecules near an orientation film in the example of the first stable orientation state of the liquid crystal molecules of the liquid crystal display device;

FIG. 3A is a diagram illustrating an orientation state of all liquid crystal molecules in an example of a second stable orientation state of the liquid crystal molecules of the liquid crystal display device;

FIG. 3B is a diagram illustrating the orientation state of the liquid crystal molecules near an orientation film in the example of the second stable orientation state of the liquid crystal molecules of the liquid crystal display device;

FIG. 4 is a diagram illustrating examples of splay deformation state and bend deformation of the liquid crystal molecules;

FIG. 5A is a diagram illustrating an example of a first stable orientation state of liquid crystal molecules of a liquid crystal display device according to a second embodiment of the invention;

FIG. 5B is a diagram illustrating an example of a second stable orientation state of the liquid crystal molecules of the liquid crystal display device according to the second embodiment of the invention;

FIG. 6 is a diagram illustrating a part of a simulation result of an example of an orientation state of liquid crystal molecules according to the invention;

FIG. 7 is a diagram illustrating another part of the simulation result of the example of the orientation state of the liquid crystal molecules according to the invention;

FIG. 8A is a diagram illustrating a stable orientation state among orientation states of liquid crystal molecules in a conventional ZBD-type liquid crystal display device; and

FIG. 8B is a diagram illustrating another stable orientation state among the orientation states of the liquid crystal molecules in the conventional ZBD-type liquid crystal display device.

### DESCRIPTION OF THE PREFERRED EMBODIMENT

A liquid crystal device according to a first embodiment of the invention will now be described with reference to the drawings.

Moreover, a thickness or a length of each element is properly adjusted in order to have a recognizable size in the drawings.

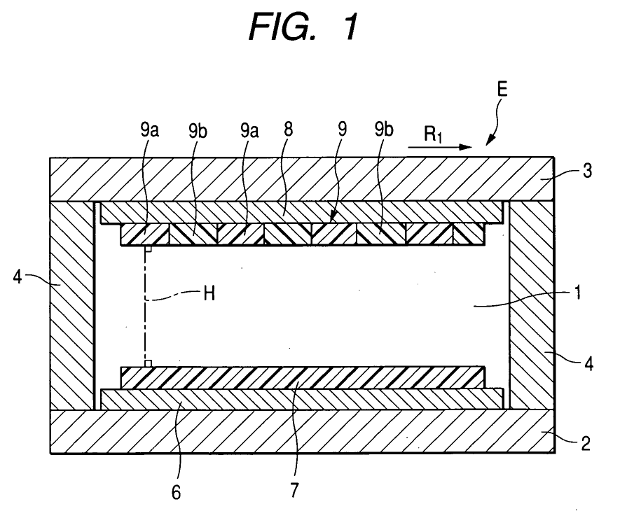

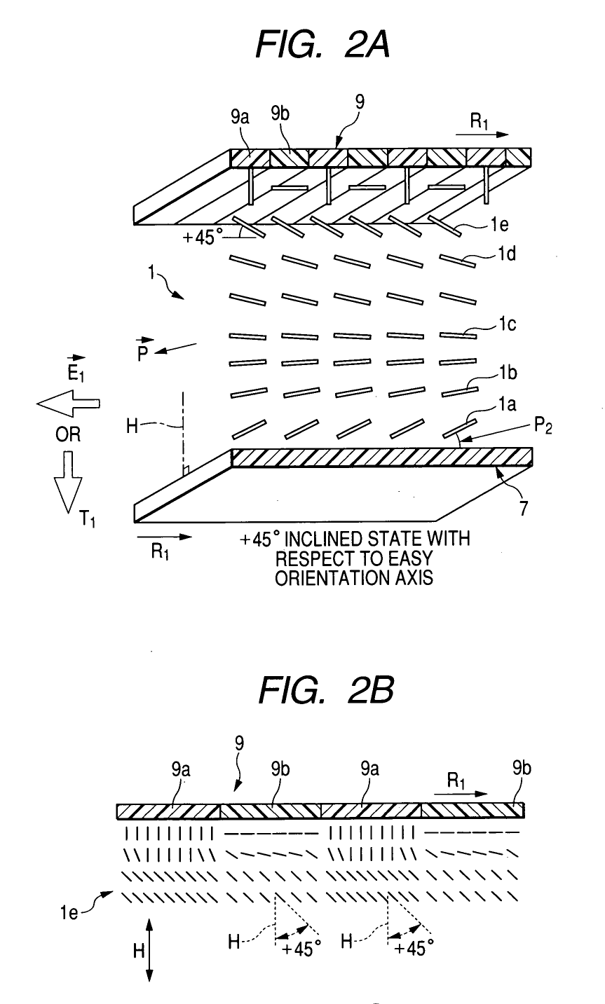

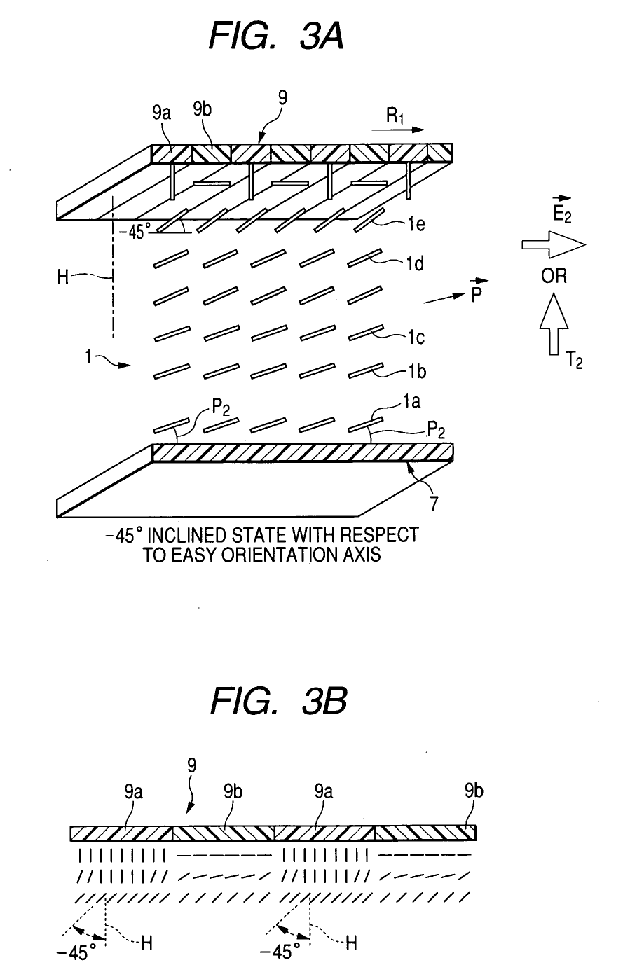

FIG. 1 is a diagram schematically showing a configuration of a liquid crystal display device according to the invention. FIGS. 2A and 2B are diagrams illustrating orientation films of the liquid crystal display device and an example of a first stable orientation state of liquid crystal molecules. FIG. 3 is a diagram illustrating an example of a second stable orientation state of the liquid crystal molecules.

The liquid crystal display device E shown in FIG. 1 has a first substrate 2 and a second substrate 3 which are made of glass, resin, or the like to face each other with a liquid crystal layer 1 made of nematic liquid crystal interposed therebetween. The first substrate 2 and the second substrate 3 are integrally bonded to each other by a sealing material 4. A display circuit 6 and an orientation film 7 are sequentially laminated on a surface of the first substrate 2 facing the liquid crystal layer 1. Further, a display circuit 8 and an orientation film 9 are sequentially laminated on a surface of the second substrate 3 facing the liquid crystal layer 1.

With regard to the liquid crystal display device E shown in FIG. 1, only essential parts in a liquid crystal display device are described. On the other hand, when the liquid crystal display device is a reflective liquid crystal display device, a reflective surface made of a metal reflective film or the like may be provided on the first substrate 2, a cell gap may be set to a required value, and, if necessary, a retardation plate or a polarizing plate may be provided. Further, when the liquid crystal display device is a transmissive liquid crystal display device, the first substrate 2 may be made of a transparent substrate, a backlight may be provided on the rear surface of the first substrate 2, a cell gap may be set to a required value, and, if necessary, a retardation plate or a polarizing plate may be provided.

Further, in the display circuits 6 and 8 shown in FIG. 1, electrode layers (not shown) which are made of transparent conductive films or metal reflective films for driving the liquid crystal molecules of the liquid crystal layer 1 are formed so as to apply the electric field to the liquid crystal molecules. Here, in a case of a passive liquid crystal display element, the electrode layer has a configuration in which a plurality of stripe electrodes are arranged on the first substrate 2 and a plurality of additional stripe electrodes are arranged on the second substrate 3 so as to cross the plurality of stripe electrodes at 90°. Further, in a case of an active liquid crystal display element, a pixel electrode and a thin film transistor or a thin film diode serving as an active element are provided for each pixel in any one of the display circuits 6 and 8 and a common electrode is provided in the other display circuit, such that the liquid crystal molecules can be driven for each pixel. With the opposing electrode structure between the substrates 2 and 3, if necessary, an application electric field which generates electric force lines from the substrate 2 toward the substrate 3 and an application electric field which generates electric force lines from the substrate 3 toward the substrate 2 can be changed.

Further, the display circuit 8 on the substrate 3 shown in FIG. 1 may be omitted and the electrode provided on the substrate 2 may have an electrode configuration in which a plurality of comb-shaped electrodes oppose to one another at predetermined intervals so as to generate a horizontal electric field. With the electrode configuration for generating the horizontal electric field, a first horizontal electric field which generates electric force lines in one direction of the surface directions of the substrate 2 and the substrate 3 and a second horizontal electric field which generates electric force lines in the direction opposite to the above-described direction (opposite direction by 180°) can be properly changeably generated. Thus, the first horizontal electric field and the second horizontal electric field can be changed.

Needless to say, in any one of the above-described electrode configurations, in some cases, color filters may be provided on the first substrate 2 or the second substrate 3 so as to perform a color display, thereby forming a color liquid crystal display device.

The invention can be applied to all types of liquid crystal display devices, regardless of presence/absence of the electrodes, the display circuits, the driving elements, or the color filters. FIG. 1 shows the liquid crystal layer 1, the substrates 2 and 3, the sealing material 4, the display circuits 6 and 8, and the orientation film 7 and 9 as the basic configuration of the liquid crystal display device.

One feature of the liquid crystal display device E according to the present embodiment is that the entire surface of the orientation film 7 on the first substrate 2 facing the liquid crystal layer 1 is formed to be a uniformly inclined orientation region and the orientation film 9 on the second substrate 3 is formed such that vertical orientation regions 9a and horizontal orientation regions 9b are alternately arranged in stripe shapes in the horizontal direction of FIG. 1.

In the present embodiment, for example, the vertical orientation regions 9a and the horizontal orientation regions 9b are formed as a collective structure of stripe-shaped regions extending in the vertical direction of FIG. 1, and the entire rubbing direction of the orientation film 9 is directed to the right side in the horizontal direction of FIG. 1 (the direction orthogonal to the stripe direction of each region: the R₁ direction in FIG. 1). Moreover, the rubbing direction may be directed to the left side in the horizontal direction of FIG. 1 (the direction different from the R₁ direction by 180°).

The width of each of the stripe-shaped vertical and horizontal orientation regions 9a and 9b is preferably in a range of from 1 to 10 μm, and more preferably, in a range of from 1 to 2 μm. Further, the rubbing direction may be a vertical direction with respect to the R₁ direction (the different direction by 90°). The structure constituted in such a manner will be described below.

A pretilt angle P₂ of the nematic liquid crystal to the orientation film 7 on the first substrate 2 changes somewhat according to the elastic constant of the liquid crystal, the anchoring strength of the orientation film 7, the pretilt angle of the horizontal orientation component of the orientation film 9, and the anchoring strength of each of the horizontal and vertical orientation components of the orientation film 9. Generally, it is preferable to be about 20° or 70°. Here, about 20° or 70° means a range of 20°±5° or a range of 70°±5°.

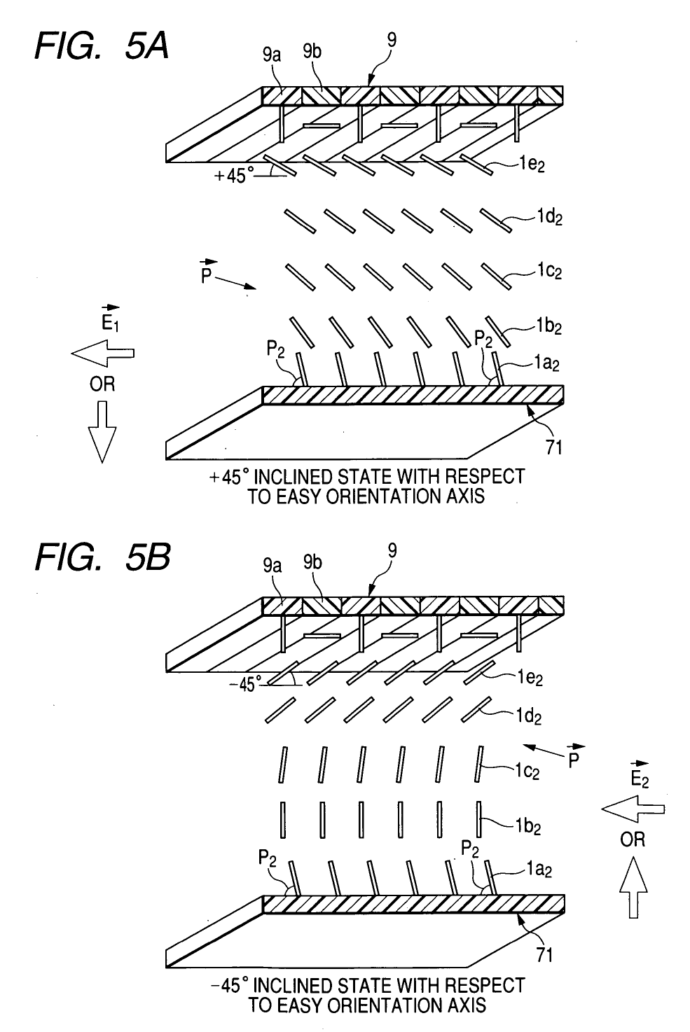

In the structure examples shown in FIGS. 2A to 3B, the pretilt angle P₂ of the nematic liquid crystal to the orientation film 7 is about 20°. FIGS. 5A and 5B show a structure example when the pretilt angle P₂ of the nematic liquid crystal to the orientation film 7 is about 70°. The structure example shown in FIGS. 5A and 5B will be described below.

As regards the configurations shown in FIGS. 2A to 3B, FIGS. 2A and 3A show the upper and lower orientation films 7 and 9 and exemplary directions of the liquid crystal molecules disposed between the orientation films at the time of the application of the electric field. FIGS. 2B and 3B show the orientation state of the liquid crystal molecules near the orientation film 9 at the time of the application of the electric field. In FIGS. 2A and 3A, the pretilt angle of the nematic liquid crystal in the horizontal orientation region of the orientation film 9 on the second substrate 3 is preferably 0° or in a range of from 0° to 5°. Further, the pretilt angle of the nematic liquid crystal in the vertical orientation region is preferably 90° or in a range of 85° to 90°.

In the respective configurations, the elastic constant and an interface anchoring strength are properly selected such that an average easy orientation axis of the liquid crystal molecules 1e near the orientation film 9 on the second substrate 3 is substantially +45° in the cases shown in FIGS. 2A and 2B and is −45° in the cases shown in FIGS. 3A and 3B.

Further, in the examples shown in FIGS. 2A to 3B, the easy orientation axis of the horizontal orientation region of the orientation film 9 on the second substrate 3 is perpendicular to the lengthwise direction of each of the stripe regions (parallel to the R₁ direction in FIGS. 2A to 3B). The easy orientation axis (rubbing direction) of the uniformly inclined orientation region of the orientation film 7 on the first substrate 2 is also perpendicular to the lengthwise direction of each of the strip regions (parallel to the R₁ direction in FIGS. 2A to 3B).

Here, the easy orientation axis (rubbing direction) of the horizontal orientation region of the orientation film 9 on the second substrate 3 may be set to be parallel to the lengthwise direction of each of the stripe regions. In this case, preferably, the easy orientation axis (rubbing direction) of the orientation film 7 on the first substrate 2 may be also set to be parallel to the lengthwise direction of each of the stripe regions.

In the example shown in FIG. 2A or 3A, for simplification of explanation, only the configuration in which the easy orientation axis of the horizontal orientation region of the orientation film 9 on the second substrate 3 is perpendicular to the lengthwise direction of each of the stripe regions (the R₁ direction) is shown.

The orientation films 7 and 9 are made of polyimide, an oblique deposition film of SiO₂, lecithin-based resin, silane-based resin, or the like. Such orientation films include variations having the pretilt angle of 1 to 2° and about 88° and thus they can be properly used.

In the liquid crystal display device E having the above-described configuration, an electric field is applied to the upper and lower display circuits 6 and 8 so as to generate leftward electric force lines E₁, as shown in FIG. 2A, or electric force lines T₁ (downward electric force lines) from the orientation film 9 on the second substrate 3 to the orientation film 7 on the first substrate 2. The, the liquid crystal molecules of the nematic liquid crystal between the orientation films 7 and 9 are oriented, as shown in FIGS. 2A and 2B.

For example, as shown in FIG. 2A, the orientation direction of the liquid crystal molecules 1a near the orientation film 7 has the pretilt angle of about −20° to the orientation film 7 on the substrate 2 along the R₁ direction. The liquid crystal molecules 1b, which are in the vicinity of the center portion in the thicknesswise direction of the liquid crystal layer 1, are in the substantially horizontal orientation states. The liquid crystal molecules 1c, which are closer to the orientation film 9 on the second substrate 3 than the liquid crystal molecules 1b, are slightly inclined. In addition, the liquid crystal molecules 1d, which are closer to the orientation film 9 on the second substrate 3 than the liquid crystal molecules 1c, are inclined at about +30°. Further, the liquid crystal molecules 1e, which are closer to the orientation film 9 on the second substrate 3 than the liquid crystal molecules 1d, are inclined at about +45° to be in homogenous states. Moreover, as shown in FIG. 2A, the states of the liquid crystal molecules having the pretilt angle of about +45° upward (downward), while being oriented along the rubbing direction of the R₁ direction, is referred to as a +45° orientation state of the easy orientation axis of the liquid crystal molecules.

Here, the reason that the liquid crystal molecules 1e disposed close to the orientation film 9 are uniformly oriented at the pretilt angle of about +45° will be described below with reference to FIG. 2B.

As shown in FIG. 2B in an enlarged scale, among the plurality of liquid crystal molecules between the orientation film 7 and the orientation film 9, the liquid crystal molecules being closest to the orientation film 9 have the vertical orientation states near the vertical orientation regions 9a and have the horizontal orientation states near the horizontal orientation regions 9b. On the other hand, in the vertical orientation regions 9a, the states of the liquid crystal molecules disposed to be slightly spaced apart from the orientation film 9 (at the positions apart from the orientation film by several molecules) are changed from the slight vertical orientation states to the inclined orientation states. In this case, the liquid crystal molecules on both sides of each of the vertical orientation regions 9a, that is, near the horizontal orientation regions 9b, are in the inclined orientation states by the influences of the horizontal orientation regions 9b neighboring to the vertical orientation regions 9a and the electric field, that is, due to influences of a torque caused by a flexoelectric polarization and a torque caused by an orientation flow effect. Similarly, in the horizontal orientation regions 9a, the states of the liquid crystal molecules disposed to be slightly spaced apart from the orientation film 9 (at the positions apart from the orientation film by several molecules) are changed from the slight horizontal orientation states to the inclined orientation states. In this case, the liquid crystal molecules on both sides of the horizontal orientation regions 9b, that is, near the vertical orientation regions 9a, are in the inclined orientation states by the influences of the vertical orientation regions 9a neighboring to the horizontal orientation regions 9b and the electric field, that is, due to the influences of the torque caused by the flexoelectric polarization and the torque by the orientation flow effect.

Due to the influences of the torque caused by the flexoelectric polarization and the torque caused by the orientation flow effect, the liquid crystal molecules 1e disposed to be slightly spaced apart from the orientation film 9 (at the positions apart from the orientation film by several molecules) are uniformly oriented at the pretilt angle of +45°.

In FIG. 2A, the liquid crystal molecules 1e at such positions are described as the liquid crystal molecules closest to the orientation film 9. However, in detail, as shown in FIG. 2B, the orientation properties of the liquid crystal molecules are gradually changed as the liquid crystal molecules are spaced apart from the orientation film 9, such that the liquid crystal molecules 1e are uniformly oriented at the pretilt angle of +45°. The liquid crystal molecules are oriented in such a manner when the leftward horizontal electric field is applied, as shown in FIG. 2A, or when the downward vertical electric field is applied. Specifically, even though any one of the electric fields is applied, the liquid crystal molecules are in the orientation states as shown in FIG. 2A. This is because the direction of the flexoelectric polarization of the liquid crystal is changed from the leftward to the slight downward in the case shown in FIG. 2A.

Here, in consideration of the real size of the liquid crystal molecule, the average length of one liquid crystal molecule is about 2 nm and the width thereof is about ⅓ to 1/10 of the length, that is, several subnanometers. Thus, even if the liquid crystal molecules are vertically arranged, several tens of thousands of liquid crystal molecules exist between the substrates 2 and 3 with the cell gap of several μm. Further, an orientation mechanism shown in FIG. 2B exists in a region where several layers of liquid crystal molecules near the orientation film 9 are disposed. For this reason, the liquid crystal molecules 1e are controlled at the angle of +45°+β (an orientation state in which the right end of the easy orientation axis of the liquid crystal molecule shown FIG. 2A is inclined toward the orientation film 7 and the left end thereof is inclined toward the orientation film 9 with regard to a line perpendicular to the substrates 2 and 3, that is, a normal H to the substrates 2 and 3).

Since the liquid crystal molecules 1a to 1d are stabilized in the states shown in FIG. 2A and are held in the states shown 2A after the electric field is removed from the electrodes, the orientation state shown in FIG. 2A becomes a first stabilization state. Further, the liquid crystal molecules 1a to 1e disposed between the orientation film 7 and the orientation film 9 are in spray orientation states. Further, when the liquid crystal molecules 1a to 1e between the orientation film 7 and the orientation film 9 are arranged in the rubbing direction in plan view, all liquid crystal molecules 1a to 1e are arranged in a direction along the rubbing direction R₁.

Next, with regard to the orientation state shown in FIG. 2A, when the rightward horizontal electric field E₂ or the electric field which generates the electric force lines T₂ from the orientation film 7 on the first substrate 2 to the orientation film 9 on the second substrate 3 as shown in FIG. 3A is applied to the liquid crystal molecules to the electrodes provided in the upper and lower display circuits 6 and 8 of the liquid crystal display device E, the liquid crystal molecules of the nematic liquid crystal are oriented as shown in FIG. 3A.

For example, the pretilt angle of the liquid crystal molecules close to the orientation film 7 is about −20° with respect to the orientation film 7. The pretilt angle of the liquid crystal molecules 1b, which are in the vicinity of the center portion in the thicknesswise direction of the liquid crystal layer 1, is about −30°. The pretilt angle of the liquid crystal molecules 1c, which are closer to the orientation film 9 on the second substrate 3 than the liquid crystal molecules 1b, is about −35°. In addition, the liquid crystal molecules 1d, which are closer to the orientation film 9 on the second substrate 3 than the liquid crystal molecules 1c, are inclined at about −40°. Further, the liquid crystal molecules 1e, which are closer to the orientation film 9 on the second substrate 3 than the liquid crystal molecules 1d, are inclined at a pretilt angle of about −45°. Since the liquid crystal molecules 1a to 1d are stabilized in the states shown in FIG. 3A and are held in the states after the electric field is removed from the electrodes, the orientation state shown in FIG. 3A is in a second stabilization state.

Here, the reason that the liquid crystal molecules 1e disposed close to the orientation film 9 are uniformly oriented at the pretilt angle of about −45° will be described below with reference to FIG. 3B.

As shown in FIG. 3B, among the plurality of liquid crystal molecules between the orientation film 7 and the orientation film 9, the liquid crystal molecules closest to the orientation film 9 are in the vertical orientation states near the vertical orientation regions 9a of the orientation film 9 and are in the horizontal orientation states near the horizontal orientation regions 9b of the orientation film 9. However, in the vertical orientation regions 9a, the states of the liquid crystal molecules disposed to be slightly spaced apart from the orientation film 9 are changed from the slight vertical orientation states to the inclined orientation states. In this case, the liquid crystal molecules on both sides of the vertical orientation regions 9a, that is, near the horizontal orientation regions 9b, are in the inclined orientation states due to the influences of the horizontal orientation regions 9b neighboring to the vertical orientation regions 9a and the electric field, that is, due to of the torque caused by the flexoelectric polarization and the torque caused by the orientation flow effect. Similarly, in the horizontal orientation regions 9b, the states of the liquid crystal molecules disposed to be slightly spaced apart from the orientation film 9 (at the positions apart from the orientation film by several molecules) are changed from the slight horizontal orientation states to the inclined orientation states. In this case, the liquid crystal molecules on both sides of the horizontal orientation regions 9b, that is, near the vertical orientation regions 9a are in the inclined orientation states due to the influences of the vertical orientation regions 9a neighboring to the horizontal orientation regions 9b and the electric field, that is, due to the torque caused by the flexoelectric polarization and the torque caused by the orientation flow effect. Due to the influences of the torque caused by the flexoelectric polarization and the torque caused by the orientation flow effect, the liquid crystal molecules 1e disposed to be slightly spaced apart from the orientation film 9 are uniformly oriented at the pretilt angle of −45°.

In FIG. 3A, the liquid crystal molecules 1e at such positions are described as the liquid crystal molecules closest to the orientation film 9. However, in detail, as shown in FIG. 3B, the orientation properties of the liquid crystal molecules are gradually changed as the liquid crystal molecules are spaced apart from the orientation film 9, such that the liquid crystal molecules 1e are uniformly oriented at the pretilt angle of −45°. The liquid crystal molecules are oriented in such a manner when the rightward horizontal electric field is applied, as shown in FIG. 3A, or when the upward vertical electric field is applied. Specifically, even if any one of the electric fields is applied, the liquid crystal molecules are oriented as shown in FIG. 3A. This is because the direction of the flexoelectric polarization of the liquid crystal is changed from the slight upward to the rightward in the case of FIG. 3A.

Here, in consideration of the real size of the liquid crystal molecule, the average length of one liquid crystal molecule is about 2 nm and the width thereof is about ⅓ to 1/10 of the length, that is, several subnanometers. Thus, even if the liquid crystal molecules are vertically arranged, several tens of thousands of liquid crystal molecules are arranged between the substrates 2 and 3 with the cell gap of several μm. Also, the orientation mechanism shown in FIG. 3B exists in a region where several layers of liquid crystal molecules near the orientation film 9 exist. For this reason, the liquid crystal molecules 1e are controlled to be oriented at the angle of −45°−β (an orientation state in which the right end of the easy orientation axis of the liquid crystal molecule shown in FIG. 3A is inclined toward the orientation film 9 and the left end thereof is inclined toward the orientation film 7 with regard to a line perpendicular to the substrates 2 and 3, that is, a normal H to the substrates 2 and 3).

Since the liquid crystal molecules 1a to 1d are stabilized in the states shown in FIG. 3A and are held in the states after the electric field is removed from the electrodes, the orientation state shown in FIG. 3A becomes the second stabilization state. Further, the liquid crystal molecules 1a to 1e between the orientation film 7 and the orientation film 9 in the spray orientation states. Further, when the liquid crystal molecules 1a to 1e between the orientation film 7 and the orientation film 9 are arranged in the rubbing direction in plan view, all liquid crystal molecules 1a to 1e are arranged in a direction along the rubbing direction R₁.

As described above, in the states shown in FIG. 2A and 3A, the liquid crystal molecules 1e close to the orientation film 9 in the states shown in FIG. 2A and 3A can be changed in a +45° direction and a −45° direction, for example, according to the direction of the electric field to be applied thereto. Further, two stable orientation states in which the orientations of the liquid crystal molecules 1e close to the orientation film 9 are different by 90° can be realized, thereby realizing the bistability.

Next, a mechanism of generating orientation control force when the nematic liquid crystal has a first orientation state and a second orientation state by the electric field which generates the electric force lines E₁ or E₂ described above, or by the electric field which generates the downward or upward electric force lines T₁ or T₂ will be described.

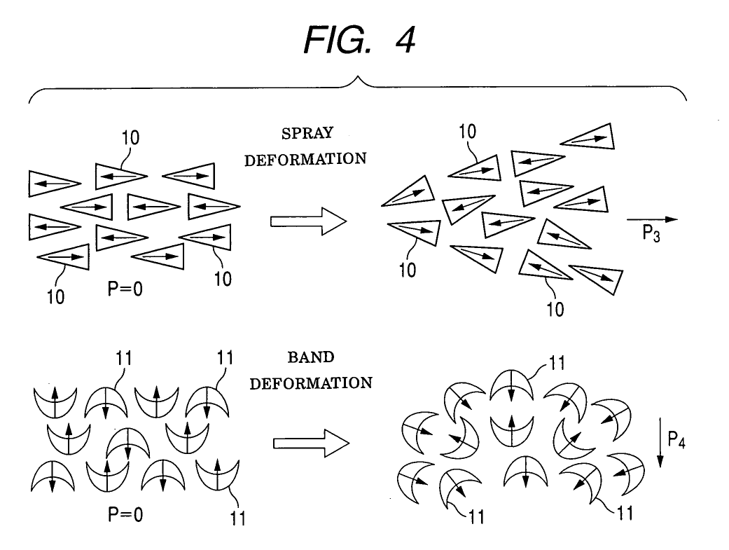

Generally, the nematic liquid crystal is defined as an aggregate of various liquid crystal molecules having different shapes, such as wedge-shaped liquid crystal molecules 10 or banana-shaped liquid crystal molecules shown in FIG. 4. In a normal state in which distortion is not applied to the nematic liquid crystal, the wide parts (wide part of molecule structure) and the narrow parts (narrow part of molecule structure) of the liquid crystal molecules having different shapes get into each other. Then, the nematic liquid crystal is held in a stable orientation state in which a dipole moment is seemingly canceled and the polarization becomes 0. However, when the distortion, such as splay (expansion) or bend, acts on the orientation state of the nematic liquid crystal as the aggregate of the liquid crystal molecules having various shapes, the dipole moment is biased and therefore the polarization occurs. This phenomenon can be referred to as a polarization phenomenon due to the flexoelectric effect.

In the nematic liquid crystal, the value of the polarization P due to the flexoelectric effect can be derived from the sum of a value of a spontaneous polarization P due to the splay deformation of the wedge-shaped liquid crystal molecules and a value of a spontaneous polarization P due to the bend deformation of the banana-shaped liquid crystal molecules. This value controls the polarization of the nematic liquid crystal.

For easy understanding, such a state is shown in FIG. 4. When the distortion caused by the splay deformation is applied to the aggregate of the wedge-shaped liquid crystal molecules 10, the spontaneous polarization P indicated by P₃ in FIG. 4 occurs. When the distortion caused by the bend deformation is applied to the aggregate of the banana-shaped liquid crystal molecules 11, the spontaneous polarization P indicated by P₄ in FIG. 4 occurs. Specifically, the nematic liquid crystal to which the splay deformation or the bend deformation is applied has the value of the spontaneous polarization P which approximates the sum of the spontaneous polarization P₃ and the spontaneous polarization P₄. Thus, when the predetermined horizontal electric field E₁ or E₂ is applied to the nematic liquid crystal, or when the downward electric field T₁ or the upward electric field T₂ is applied to the nematic liquid crystal, the nematic liquid crystal has spontaneously a specific orientation state according to the value or the direction of the spontaneous polarization P. Specifically, the torque caused by the flexoelectric effect occurs and the liquid crystal molecules are oriented under the influence of the torque and are stabilized in the state.

Further, the torque caused by the flexoelectric effect is easily propagated to other adjacent liquid crystal molecules with the orientation flowability. Further, the flow of the liquid crystal molecules which are oriented by the flexoelectric effect is propagated to other liquid crystal molecules neighboring to the liquid crystal molecules oriented by the torque caused by the flexoelectric effect, such that other liquid crystal molecules are oriented similarly and sequentially. Therefore, all liquid crystal molecules can be in the prescribed orientation states.

Further, when the orientation directions of other liquid crystal molecules are changed by the torque, which is propagated to the other liquid crystal molecules according to the flow of the liquid crystal molecules other liquid crystal molecules are oriented according to the same flow direction. Therefore, multiple domains, which can occur in the ZBD-type liquid crystal display device according to the related art, do not occur in the liquid crystal display device according to the invention. As a result, an orientation state for display can be obtained, without generating the domains.

When the above-described torch reaction caused by the spontaneous polarization is used and the liquid crystal interposed between a pair of substrate is oriented in a state in which the spontaneous polarization properly occurs between the orientation films of both substrates, that is, when the liquid crystal has the orientation state described above with reference to FIG. 2 or FIG. 3, the application condition of the electric field can be selected according to the spontaneous polarization P revealed by the nematic liquid crystal, thereby allowing the bistability of the nematic liquid crystal to be revealed.

To this end, as described above, first, the orientation film 7 on one substrate 2 is subjected to the uniform orientation treatment, for example, the inclined orientation treatment, the vertical orientation regions 9a and the horizontal orientation regions 9b are alternately formed in the orientation film 9 on the other substrate 3, and the spontaneous polarization P is allowed to be revealed in the nematic liquid crystal. Then, from the electrodes of the two substrates, the downward electric force lines T₁ toward the one substrate 2 in the direction perpendicular to the substrates are generated or the upward electric force lines T₂ toward the other substrate 3 are generated. Accordingly, the bistability of the nematic liquid crystal can be revealed. Also, when the horizontal electric field is applied, the leftward horizontal electric field E₁ or the rightward horizontal electric field E₂ shown in FIG. 2A may be applied from the counter electrodes which have the comb shapes and are provided on one of the substrates in a pair.

Then, though not shown in FIGS. 1 to 3B, by disposing crossed nicols polarizing plates outside the substrates 2 and 3 so as to change a transmission state of light in the state shown in FIG. 2A or 2B and in the state shown in FIG. 3A or 3B, the light state and the dark state can be changed. Further, the light display and the dark display can be changed by transmitting and shielding transmitted light or reflected light in the liquid crystal display device E.

In this case, since the spontaneous polarization P due to the flexoelectric effect acts at high speed, the response can be quickly changed. Further, since the liquid crystal display device E having such a configuration performs the quick change between the light display and the dark display, it can be effectively used for the display on an electronic paper device or the like, which performs a quick writing operation. Further, since the orientation states shown in FIGS. 2A to 3B are maintained even though the electric field is removed, the electric field does not need to be applied after the orientation state is changed once. Therefore, when the orientation states shown in FIGS. 2A and 3B are maintained, low power consumption can be achieved.

The liquid crystal display device E constructed as described above does not have the gratings in the order of micrometers having a triangular cross section on the upper substrate, which are required for the ZBD-type liquid crystal display device according to the related art. Further, the liquid crystal display device E has the orientation film 9 with the vertical orientation regions and the horizontal orientation regions 9b which are alternately disposed on the substrate 3. Thus, the liquid crystal display device can be easily manufactured.

FIGS. 5A and 5B show a liquid crystal display device according to a second embodiment of the invention. The configuration of the second embodiment corresponds to a case in which the pretilt angle P₂ of the nematic liquid crystal to the orientation film 7 on the substrate 2 is about 70° in the configuration of the first embodiment.

In the configuration of the second embodiment, the orientation film 9 and the orientation states and directions of the liquid crystal molecules closest to the orientation film 9 and the liquid crystal molecules 1e₂ close to the orientation film 9 are the same as those in the above-described embodiment.

In the present embodiment, the orientation states of the liquid crystal molecules 1a₂, 1b₂, 1c₂, and 1d₂ closer to an orientation film 71 than the liquid crystal molecules 1e₂ are different from those in the above-described embodiment.

Similarly, the liquid crystal molecules close to the orientation film 71 having the pretilt angle of about 70° are gradually inclined from standing states as the liquid crystal molecules are closer to the orientation film 9, such that the liquid crystal molecules 1e₂ are in the states shown in FIG. 2A or the state shown in FIG. 3A in the above-described embodiment. Therefore, the bistability can be revealed by a first stabilization state shown in FIG. 5A and a second stabilization state shown in FIG. 5B.

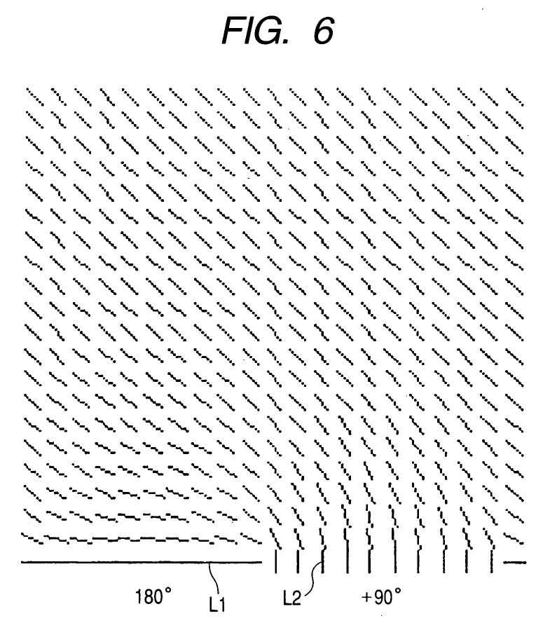

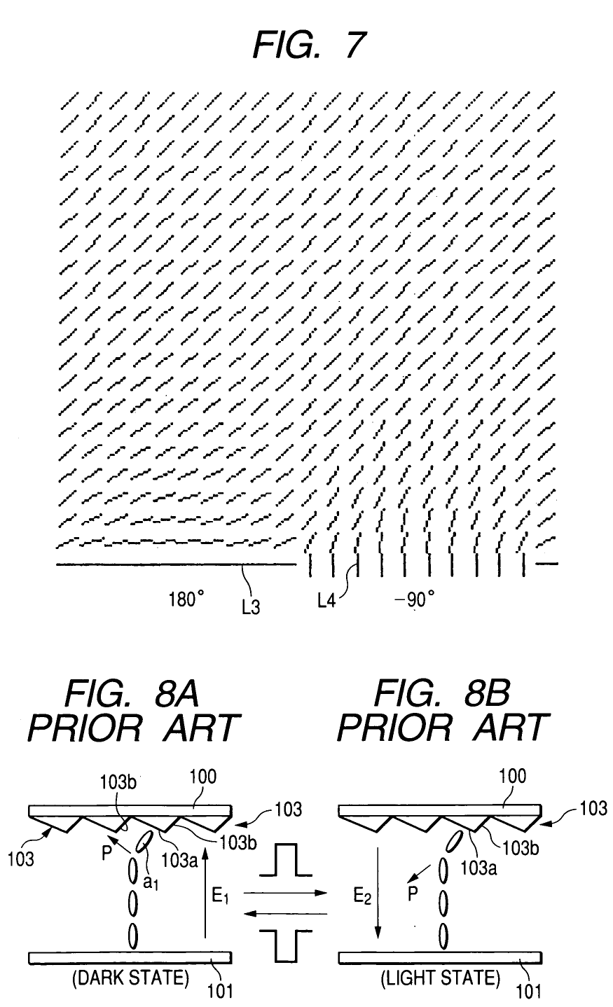

FIGS. 6 and 7 show simulation results of the orientation states of the liquid crystal molecules using a finite element method. In FIG. 6, the horizontal orientation region of the orientation film is indicated by the line L1 above the description of 180°, the vertical orientation region of the orientation film is indicated by multiple vertical lines L2 on the right side of the line L1, and the orientations of the liquid crystal molecules are shown above the lines. Also, in FIG. 7, the horizontal orientation region of the orientation film is indicated by a line L3 above the description of 180°, the vertical orientation region of the orientation film is indicated by multiple vertical lines L4 on the right side of the line L1, and the orientations of the liquid crystal molecules are shown above the lines. In FIGS. 6 and 7, the uppermost liquid crystal molecules show the orientation states of the liquid crystal molecules neighboring to the liquid crystal molecules 1d shown in FIG. 2A, and the lowermost liquid crystal molecules show the orientations of the liquid crystal molecules closest to the vertical orientation region and the horizontal orientation region of the orientation film 9.

From the simulation results shown in FIGS. 6 and 7, it can be seen that the two stable orientation states of the liquid crystal molecules are obtained.

According to the first or second aspect of the invention, the orientation film on the one substrate is subjected to the uniform inclined orientation treatment and the orientation film on the other substrate has the vertical orientation regions and the horizontal orientation regions to be alternately formed. Thus, the flexoelectric polarization can occur by alternately controlling the orientations of the liquid crystal molecules closest to the orientation film having the vertical orientation regions and the horizontal orientation regions alternately to the vertical orientation state and the horizontal orientation state. The liquid crystal molecules of which orientations are controlled to the vertical orientation state and the liquid crystal molecules of which orientations are controlled to the horizontal orientation state are also influenced by the electric field and affect each other. Accordingly, as the liquid crystal molecules are spaced apart from the orientation film of the vertical orientation state and the orientation film of the horizontal orientation state, the liquid crystal molecules at positions corresponding to those regions can have the bistability having two states in which an easy orientation axis meet a normal of the pair of substrates at +β° and at −β° by change of the electric field, respectively, in the entire surface of the orientation film on the other substrate. Therefore, a bistable liquid crystal display device can be provided.

As such, a bistable liquid crystal display device can be provided, in which the orientation state of the liquid crystal can be changed by the change of the application state of the electric field, without periodically forming minute triangle concavo-convexes of the size in the order of micrometers required for the ZBD-type liquid crystal display device known as a bistable liquid crystal display device.

1. A bistable liquid crystal display device comprising:
nematic liquid crystal that is interposed between a pair of substrates;
an orientation film that is subjected to a uniform inclined orientation treatment and an electrode that drives the liquid crystal, on one of the substrates; and
an orientation film that has vertical orientation regions and horizontal orientation regions alternately formed and an electrode for driving the liquid crystal, on the other substrate,
wherein, when an electric field that generates electric force lines toward the one substrate is applied from the electrodes on the pair of substrates and when an electric field that generates electric force lines toward the other substrate is applied from the electrodes on the pair of substrates, an angle of an easy orientation axis of liquid crystal molecules close to the other substrate is changed between an orientation state in which one end of the easy orientation axis of the liquid crystal molecules is inclined toward the one substrate with respect to a normal of the pair of substrates and an orientation state in which the one end of the easy orientation axis of the liquid crystal molecules is inclined toward the other substrate with respect to the normal of the pair of substrates is changed, thereby allowing a bistable state in which two orientation states are stabilized to be revealed.

2. A bistable liquid crystal display device comprising:
nematic liquid crystal that is interposed between a pair of substrates;
an orientation film that is subjected to a uniform inclined orientation treatment on one of the substrates;
an orientation film that has vertical orientation regions and horizontal orientation regions to be alternately formed on the other substrate; and
electrodes that is formed on at least one of the pair of substrates to drive the liquid crystal and to generate a horizontal electric field,
wherein, when a horizontal electric field is applied from the electrodes for driving the liquid crystal in a direction along the vertical orientation regions and the horizontal orientation regions to be alternately formed and when a horizontal electric field is applied from the electrodes for driving the liquid crystal in an opposite direction to the direction, an angle of an easy orientation axis of liquid crystal molecules close to the other substrate is changed between an orientation state in which one end of the easy orientation axis of the liquid crystal molecules is inclined toward the one substrate with respect to a normal of the pair of substrates and an orientation state in which the one end of the easy orientation axis of the liquid crystal molecules is inclined toward the other substrate with respect to the normal of the pair of substrates, thereby allowing a bistable state in which the two orientation states are stabilized to be revealed.

3. The bistable liquid crystal display device according to claim 1,
wherein, when flexoelectric polarization by a flexoelectric effect is imparted in the nematic liquid crystal, the bistable state is changed due to a torque caused by the flexoelectric polarization and a torque caused by an orientation flow effect.

4. The bistable liquid crystal display device according to claim 1,
wherein a rubbing treatment is performed on the orientation film on the other substrate in an alternate formation direction of the vertical orientation regions and the horizontal orientation regions on the other substrate or in a direction perpendicular to the alternate formation direction.

5. The bistable liquid crystal display device according to claim 1,
wherein a pretilt angle of the orientation film subjected to the uniform inclined orientation treatment on the one substrate is in a range of 20°±5° or in a range of 70°±5°.

6. The bistable liquid crystal display device according to claim 1,
wherein the vertical orientation regions and the horizontal orientation regions on the other substrate have stripe shapes, respectively, and are alternately arranged along the surface direction of the substrate.

7. The bistable liquid crystal display device according to claim 1,
wherein the vertical orientation regions and the horizontal orientation regions on the other substrate have rectangular shapes, respectively, and are alternately arranged along the surface direction of the substrate.

8. The bistable liquid crystal display device according to claim 1, further comprising:
optical compensation films that are disposed outside the pair of substrates,
wherein the orientation direction of the liquid crystal in the horizontal orientation regions on the other substrate crosses directions of polarization axes of the optical compensation films at an angle of ±45°.

9. The bistable liquid crystal display device according to claim 2,
wherein, when flexoelectric polarization by a flexoelectric effect is imparted in the nematic liquid crystal, the bistable state is changed due to a torque caused by the flexoelectric polarization and a torque caused by an orientation flow effect.

10. The bistable liquid crystal display device according to claim 2,
wherein a rubbing treatment is performed on the orientation film on the other substrate in an alternate formation direction of the vertical orientation regions and the horizontal orientation regions on the other substrate or in a direction perpendicular to the alternate formation direction.

11. The bistable liquid crystal display device according to claim 2,
wherein a pretilt angle of the orientation film subjected to the uniform inclined orientation treatment on the one substrate is in a range of 20°±5° or in a range of 70°±5°.

12. The bistable liquid crystal display device according to claim 2,
wherein the vertical orientation regions and the horizontal orientation regions on the other substrate have stripe shapes, respectively, and are alternately arranged along the surface direction of the substrate.

13. The bistable liquid crystal display device according to claim 2,
wherein the vertical orientation regions and the horizontal orientation regions on the other substrate have rectangular shapes, respectively, and are alternately arranged along the surface direction of the substrate.

14. The bistable liquid crystal display device according to claim 2, further comprising:
optical compensation films that are disposed outside the pair of substrates,
wherein the orientation direction of the liquid crystal in the horizontal orientation regions on the other substrate crosses directions of polarization axes of the optical compensation films at an angle of ±45°.
